(19) United States
(12) Patent Application Publication
(10) Pub. No.: US 2015/0099084 A1
(43) Pub. Date: Apr. 9, 2015

(54) COMPOUND COMPONENT

(71) Applicant: MAGNA STEYR Fahrzeugtechnik AG & Co KG, Graz (AT)

(72) Inventor: Franz MAYR, St. Marein bei Graz (AT)

(21) Appl. No.: 14/508,099

(22) Filed: Oct. 7, 2014

(30) Foreign Application Priority Data
Oct. 8, 2013 (EP) 13187685.6

(51) Int. Cl. B32B 7/12; B32B 37/12

(52) U.S. Cl. CPC B32B 7/12; B32B 37/12; B32B 2605/00
USPC 428/58; 156/60; 156/272.2; 29/428

(57) ABSTRACT

A component composite that includes a first component, a second component; and at least one connection piece penetrating the first component at least over the entire thickness of the first component and connected at an end thereof to the second component.

### CROSS-REFERENCE TO RELATED APPLICATIONS

The present application claims priority 35 U.S.C. §119 to European Patent Publication No. EP 13187685.6 (filed on Oct. 8, 2013), which is hereby incorporated by reference in its entirety.

### TECHNICAL FIELD

Embodiments relate to a component composite including a first component, a second component, and at least one connection piece to penetrate the first component at least over an entire thickness of the first component.

### BACKGROUND

Component composites may be used, for example, as composites of plastics or fibre composite plates in vehicle construction. It is customary to adhesively bond, to rivet or to thermally press the components to one another. Particularly in large-scale industrial production, however, the quality of the known adhesively bonded and pressed connections is often insufficient or inconsistent. Some connection processes may only be used with difficulty or not at all if there is no accessibility for required tools, for instance welding instruments. Instances of undesirably high thermal loading for the components to be connected may occur particularly in welding processes. The production of a large number of connection points between two components may also take a long time if the connection points may only be produced in chronological succession.

U.S. Pat. No. 6,534,194 B2 and U.S. Pat. No. 6,736,942 B2, respectively disclose, inter alia, a process for thermally joining components which makes use of activatable reactive foils, what are termed nanofoils. Nanofoils are made up of alternate layer sequences of often thousands of aluminum and nickel foils having an extremely small material thickness, may be placed between the components to be joined and, upon activation, generate process heat which is effectively locally located.

### SUMMARY

In accordance with embodiments, a component composite is provided and which may include a first component and a second component which may be produced simply and reliably in terms of the process and in the process makes it possible to achieve a reliable connection between the components.

In accordance with embodiments, a simple process for producing such a component composite is also provided.

In accordance with embodiments, a component composite may include at least one of: a first component, a second component, and at least one connection piece penetrating the first component at least over the entire thickness of the first component, wherein an end of the connection piece which faces towards the second component is connected via welded to the second component or to a second connection piece fixed on the second component by way of a reactive foil such as a nanofoil.

In accordance with embodiments, a process for producing a component composite includes at least one of: introducing a connection piece into a first component; and connecting, via a weld, an end of the connection piece which faces towards a second component to one of the second component or a second connection piece fixed on the second component via a reactive foil such as a nanofoil.

In accordance with embodiments, the first component, for example a fibre-reinforced plastics plate, has at least one or a plurality of connection pieces, which is/are driven through the first component or else has already been worked into the first component during the production thereof. Through the selection of a suitable material, for example, the connection piece(s) may be optimized for connection to a second component via a reactive foil, which is applied to a surface of the connection piece. In a component composite according to the invention, the connection piece is joined directly to the second component via the reactive foil or else is joined indirectly to the second component via a second connection piece.

In accordance with embodiments, the second connection piece may in particular penetrate the second component and, for example, may have the same construction as the first connection piece which penetrates the first component.

In accordance with embodiments, a component composite may include at least one of: a first component; a second component; and at least one connection piece penetrating the first component at least over the entire thickness of the first component and connected at an end thereof to the second component.

In accordance with embodiments, a component composite may include at least one of: a first component; a first connection piece penetrating the first component the first component; a second component; and a second connection piece penetrating the second component, wherein the first connection piece and the second connection piece are connected to each other at respective ends thereof.

In accordance with embodiments, a process for producing a component composite ma include at least one of: providing a first component and a second component; introducing a connection piece into the first component at least over the entire thickness of the first component; and connecting the connection piece to the second component to thereby connect the first component and the second component.

In accordance with embodiments, if the first connection piece, which penetrates the first component, also almost or entirely penetrates the second component, the first connection piece may be welded to that surface of the second component which is remote from the first component. It is preferable that a third connection piece, for example a disc, may cover the opening which is formed through the second connection piece penetrating the second component on that side of the second component which is remote from the first component, and that the reactive foil may be positioned between the first connection piece and the third connection piece, or the disc, where it may be welded.

As a result of the brief and locally limited heating of the joining process, a component composite in accordance with embodiments may use components and connection pieces which would be subjected to excessive loading by other joining processes. The reactive foil may also be used at many positions, for example, on many connection pieces, and may thus provide a component composite having a large number of connection points with a uniformly high quality.

Developments of the invention are set forth in the dependent claims, the description and the accompanying drawings.

In particular, the first component is a plate or a shaped part and/or the second component is a plate or a shaped part. “Plate” or “shaped part” are to be understood not only as planar parts or parts extending substantially in one plane, but also as structural components or shaped parts, such as, for example, pressed parts, forged parts and drawn parts or profiled rods or sheet shapes or locally crimped tubes or cast shapes and the like.

It is preferable that there are a plurality of connection pieces in the first component, these each penetrating the first component over the entire thickness of the first component and being welded, at an end which faces towards the second component, to the second component or to further connection pieces fixed on the second component via a respective reactive foil, in particular a nanofoil. In this way, it is also possible for large-area components to be reliably connected to one another via a plurality of connection points.

The connection piece may have a cylindrical form or a pin-like form or may be in the form of a pin with a head; this may similarly be the case, if appropriate, for the further connection piece, which additionally may also be configured as a disc or plate. Shapes without a head are particularly suitable for connections of three components, i.e., where the first component is welded on the one hand to a second component and at the other end of the connection piece to a third component, or for example a disc. Shapes of the connection piece with a head are in turn particularly suitable where the connection piece is welded only on one side, in which case the head may bear against the first component at the opposite side thereof and may secure the first component at this end against axial displacement.

Depending on the components used, the connection piece and/or the further connection piece may preferably consist of metal, in particular, of non-ferrous metal, steel or aluminum or else of plastic.

In accordance with embodiments, the first component is composed of plastic or a fibre composite. In particular, the first component is a plastics plate or a fibre composite plate.

In accordance with embodiments, the second component is composed of one of metal, plastic or a fibre composite material. In particular, the second component is a metal plate, a metal sheet, a plastics plate or a fibre composite plate.

In accordance with embodiments, it is thus possible to establish, for example, a connection between various materials, specifically, between plastic or fibre composite on the one hand and metal on the other hand.

In accordance with embodiments, the bottom side and/or the top side of the reactive foil has a bonding layer. The reactive foil may thereby be adhesively bonded to a connection piece in a simple manner.

In accordance with embodiments, the surface area of the reactive foil is less than the contact surface of the connection piece on the second component or on the second connection piece fixed on the second component.

In accordance with embodiments, the connection piece is connected to the first component in an integral and/or positively locking manner, and particularly, is fixedly connected to the first component in terms of rotation.

In accordance with embodiments, the second connection piece is fixed on the second component in an integral and/or positively locking manner, or the second connection piece lies on the second component and is fixed on the second component in a non-positively locking manner only via weld to the first connection piece penetrating the first component.

In accordance with embodiments, the connection piece has a cylindrical or pin-like configuration and is welded at one end to the second component and at the opposite end to a third component, in particular, at both ends thereof to a metal sheet.

In accordance with embodiments, the connection piece is configured as a pin with a head and is welded at that end at which the connection piece does not have a head to the second component, in particular, a metal sheet.

In accordance with embodiments, the connection piece is configured as a pin with a head and is welded at that end at which the connection piece does not have a head to a second connection piece penetrating the second component.

In accordance with embodiments, a component composite may include, in addition to the first component, one or more additional components, in particular further plates or shaped parts, may also be arranged on the connection piece, such that the connection piece penetrates the first component and the additional components at least over the entire thickness of the first component and of the additional components. The connection piece may then be welded to the second component and if appropriate at the other end also to a third component.

In accordance with embodiments, a process for producing a component composite may include introducing a plurality of connection pieces into the first component; and thereafter spatially positioning the second component in relation to the first component; and thereafter connecting, via welding, the connection pieces to the second component and/or to further connection pieces fixed on the second component via a reactive foil, in particular a nanofoil. It is preferable that a separate reactive foil is used on each connection piece. It is also possible, however, for a common reactive foil for a plurality of connection pieces to be used, in which case the composition of the foil may be locally different, adapted to the positions of the connection pieces or for the forwarding of the ignition power.

In accordance with embodiments, the common reactive foil for a plurality of connection pieces may be configured in such a manner that it generates locally different process energies or process heat after it has been activated.

In accordance with embodiments, the common reactive foil for a plurality of connection pieces may be configured such that it generates process energies or levels of process heat which are uncritical for the components or relatively low in regions in which no connection pieces are arranged between the components.

In accordance with embodiments, the common reactive foil for a plurality of connection pieces may be configured such that it generates process energies or levels of process heat which are relatively high or sufficient for the welding of the components and connection pieces in regions in which the connection pieces are located.

In accordance with embodiments, the reactive foils, in particular, for each individual connection piece, are applied mechanically to the connection pieces in the first component.

In accordance with embodiments, the reactive foils may be taken, for example, by a suitable apparatus, from a batch of nanofoils, which may be provided on a non-electrically conductive carrier foil, and adhesively bonded to the connection pieces.

In accordance with embodiments, the reactive foils may be activated by the introduction of temperature, pressure or electric voltage. It is particularly efficient if reactive foils are activated at the same time on a plurality of connection pieces.

### DRAWINGS

Embodiments will be illustrated by way of example in the drawings and explained in the description below.

FIG. 1a illustrates a side view of reactive foils, in accordance with embodiments.

FIG. 1b illustrates a top view of the reactive coils of FIG. 1a.

FIG. 2a illustrates a side view of a component composite before joining, in accordance with embodiments.

FIG. 2b illustrates a top view of the component composite of FIG. 2a.

FIG. 3 illustrates the component composite, of FIG. 2a, after joining.

FIG. 4 illustrates a side view of a component composite, in accordance with embodiments.

FIG. 5 illustrates a side view of a component composite, in accordance with embodiments.

FIG. 6 illustrates a side view of a component composite, before joining, in accordance with embodiments.

### DESCRIPTION

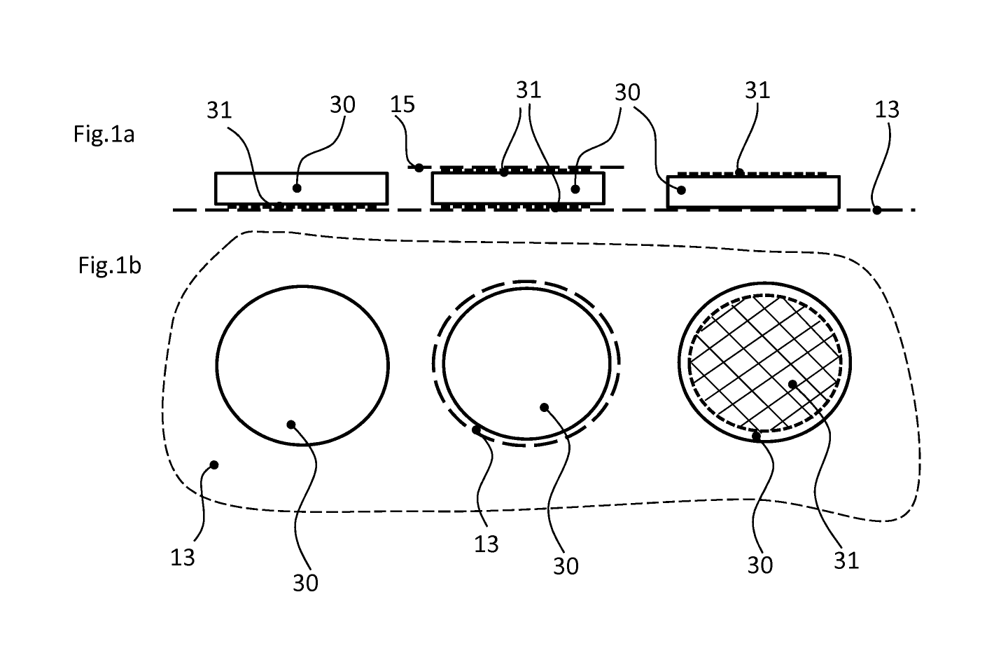

FIGS. 1a and 1b illustrate, in accordance with embodiments, reactive foils 30 which may be utilized for a process for producing a component composite. A plurality of reactive foils 30 are arranged on and/or over a thin, electrically non-conductive carrier foil 13 for transportation. The reactive foils 30 have already been equipped with a bonding layer 31 on one side or on two sides thereof. The bonding layer 31 is to simplify the subsequent adhesive bonding to a connection piece. A cover foil 15 has been applied to an upper bonding layer 31 of the reactive foil 30 illustrated in the centre of FIG. 1a.

As illustrated in FIG. 1b, the reactive foils 30 have a round geometric configuration, and thus, are suitable in particular for application to connection pieces having a round cross-section.

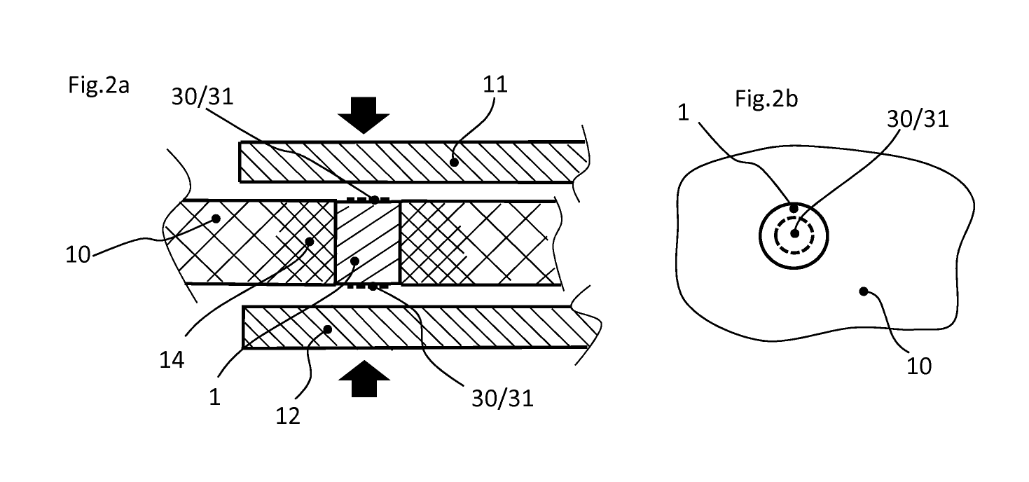

FIG. 2a illustrates, in accordance with embodiments, a component composite before joining. A cylindrical connection piece 1, with reactive foils 30 adhesively bonded on at both ends, is introduced into a fibre-reinforced plastics plate as a first component 10. The height of the connection piece 1 corresponds approximately to the height of the first component 10, in which respect the height of the connection piece 1 is chosen to be slightly greater when the reactive foil 30 is activated by pressure, i.e., may also protrude beyond the first component 10, and is chosen to be somewhat smaller upon activation via temperature or electric voltage, but at least corresponding to the thickness of the first component 10 minus the thickness of the reactive foil 30.

Two metallic sheets as a second component 11 and a third component 12, are fixed to the first component 10 on either side thereof via the activation of the reactive foil 30, for example, by pressure in the direction of the arrows illustrated or by temperature. The connection piece 1 is interwoven into the first component 10, resulting in compaction 14 of the fibres in the region around the connection piece 1.

FIG. 2b illustrates a plan view of the fibre-reinforced plastics plate as the first component 10 with the round connection piece 1 introduced and the reactive foil 30 with bonding layer 31. The reactive foil 30 has a smaller radius than the connection piece 1.

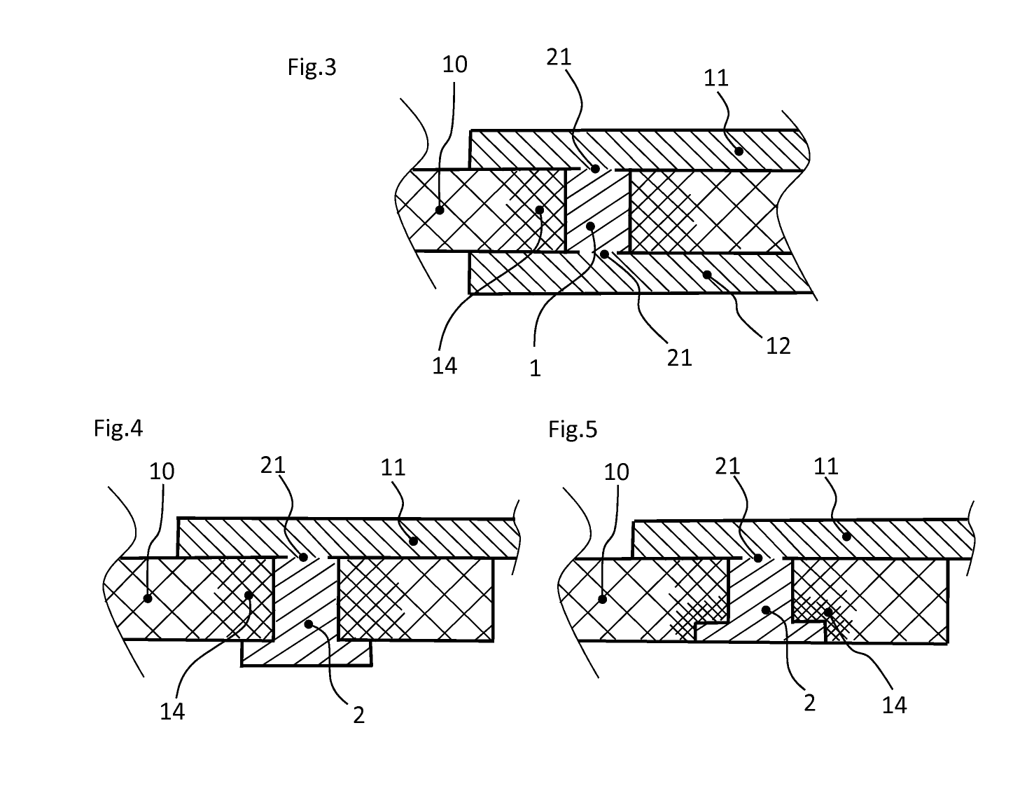

FIG. 3 illustrates the component composite of FIG. 2a after the joining operation has been carried out. Welding zones 21 are formed in each case between the first component 10 and the second component 11 or the third component 12.

FIGS. 4 and 5 illustrate, respectively, a component composite in accordance with embodiments, with a first component 10 and a second component 11, for example, a metal sheet, joined on one side of the first component 10. The first component 10 and the second component 11 are connected using a connection piece 2, which is configured as a pin with a head and is welded, at an opposite end of the connection piece 2, to the second component 11 to thereby form a welding zone 21. As illustrated in FIG. 4, the head of the connection piece 2 may rest on the first component 10. As illustrated in FIG. 5, the outer surface of the head of the connection piece 2 may be flush with the surface of the first component 10.

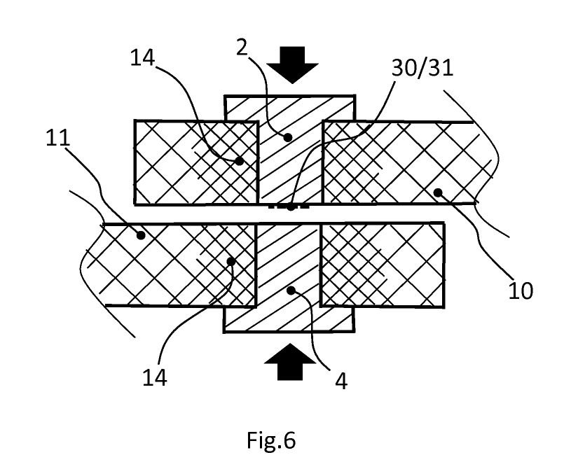

As illustrated in FIG. 6, in accordance with embodiments, the head of a connection piece 2 penetrating a first component 10 is configured as a pin with a head and is welded, at an opposite end of the connection piece 2, to the second component 11. In particular, the connection piece 2 is welded to a second connection piece 4 penetrating a second component 11. The first component 10 and the second component 11, therefore, have corresponding connection pieces 2, 4 which have already been introduced, for example, interwoven, before joining, and therefore, each have instances of compaction 14 around the connection pieces 2, 4. The first component 10 and the second component 11 may be fibre-reinforced plastics plates.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

1, 2 Connection piece
4 Second connection piece
10 First component
11 Second component
12 Third component
13 Carrier foil
14 Compaction
15 Cover foil
21 Welding zone
30 Reactive foil
31 Bonding layer

What is claimed is:

1. A component composite comprising:
a first component;
a second component; and
at least one connection piece penetrating the first component at least over the entire thickness of the first component and connected at an end thereof to the second component.

2. The component composite of claim 1, wherein:
the first component is a plate; and/or
the second component is a plate.

3. The component composite of claim 1, wherein the at least one connection piece comprises a plurality of connection pieces.

4. The component composite of claim 1, wherein the at least one connection piece has a form of a pin with a head.

5. The component composite of claim 1, wherein the connection piece is composed of one of a non-ferrous metal, steel, aluminum, and plastic.

6. The component composite of claim 1, wherein the first component is composed of one of plastic and a fibre composite material.

7. The component composite of claim 1, wherein the second component is composed of one of metal, plastic and a fibre composite material.

8. The component composite of claim 1, wherein the connection piece is connected to the first component in an integral and/or positively locking manner.

9. The component composite of claim 1, wherein the connection piece is connected at one end to the second component and at an opposite end to a third component.

10. The component composite of claim 1, wherein the connection piece is configured as a pin with a head and is connected to the second component at an end opposite to the head.

11. The component composite of claim 1, wherein the connection piece has with a nanofoil adhesively bonded thereon at both ends thereof.

12. The component composite of claim 11, wherein the nanofoil foil has a bonding layer on at least one side thereof.

13. The component composite of claim 11, wherein the surface area of the nanofoil foil is less than a contact surface of the connection piece on the second component.

14. The component composite of claim 1, wherein the at least one connection piece is connected via weld to the second component.

15. A component composite comprising:
a first component;
a first connection piece penetrating the first component the first component;
a second component; and
a second connection piece penetrating the second component,
wherein the first connection piece and the second connection piece are connected to each other at respective ends thereof.

16. The component composite of claim 1, wherein:
the first connection piece has with a nanofoil foil adhesively bonded thereon at both ends thereof; and
the nanofoil foil has a bonding layer on at least one side thereof.

17. A process for producing a component composite, comprising:
providing a first component and a second component; and
introducing a connection piece into the first component at least over the entire thickness of the first component; and
connecting the connection piece to the second component to thereby connect the first component and the second component.

18. The process of claim 17, further comprising:
introducing a plurality of connection pieces into the first component;
positioning the second component relative to the first component; and
connecting the first component and the second component by connecting the connection pieces to the second component.

19. The process of claim 17, further comprising adhesively bonding a nanofoil to the connection piece, wherein the first component and the second component is connected to each other via the nanofoil.

20. The process of claim 19, further comprising activating the reactive foil by introducing one of temperature, pressure or electric voltage thereto.
